(19) United States
(12) Patent Application Publication
(10) Pub. No.: US 2014/0143567 A1
(43) Pub. Date: May 22, 2014

(54) INTELLIGENT DEVICE FOR THE DISPLAY OF DATA IN A POWER CONSTRAINED ENVIRONMENT

(71) Applicant: MARK ANDERSON, Melbourne (AU)

(72) Inventor: MARK ANDERSON, Melbourne (AU)

(73) Assignee: Percepscion Pty. Ltd., Melbourne (AU)

(21) Appl. No.: 13/678,662

(22) Filed: Nov. 16, 2012

(51) Int. Cl. G06F 1/32

(52) U.S. Cl. CPC G06F 1/3234
USPC 713/323

(57) ABSTRACT

An intelligent device is provided which includes an housing and an attachment means to attach the housing of the intelligent device to an object. A processor is provided which is housed within the housing, and a movement sensor is coupled to the processor for detecting movement of the object to which the housing of the intelligent device is attached. Further provided is a display means coupled to the processor. The processor of the device is responsive to the sensor detecting movement of the object to reconfigure from a first low-power state to a second working state for a pre-determined period of time, such that during the pre-determined period of time the processor retrieves data and displays said data on the display means. The processor is further operable to revert back to the first low-power state when the pre-determined period of time has expired.

### TECHNICAL FIELD

Described embodiments generally relate to an intelligent device for the display of data in a power constrained environment. Such a device may be an in-home display such as a home energy monitor or smart meter.

### BACKGROUND

Many target markets are characterized by periodic transfer of small amounts of information between sensor nodes and a central device. Some identified end products which may implement a low-power radio system include health and fitness devices, remote controls, and smart meters. These applications are all constrained by the following critical key requirements: low or ultra-low-power, low cost, and physical size.

Use of home energy monitors and smart meters have risen exponentially over the last few years. A smart meter is an electric meter that records consumption of electrical energy in regular intervals and communicates that information at least daily back to the utility for monitoring and billing purposes. Home energy monitors on the other hand typically receive information concerning consumption of electrical energy and continuously displays said information and data relating to the consumption for the user to see. With either device, a user is able to modify their behaviour in an attempt to minimize energy consumption.

Such monitors typically rely on wireless technologies, and such technologies have been available for decades. However, without intelligent management of when such monitors display information, it is difficult to build monitors which meet a balance of an acceptable cost, size and battery life.

It is desired to address or ameliorate one or more shortcomings or disadvantages associated with existing in-home displays, home energy monitors or smart meters, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

An intelligent device for the display of data in a power constrained environment is provided, the intelligent device comprising:
a housing;
an attachment means to attach the housing of the intelligent device to an object;
a processor housed within the housing;
a movement sensor coupled to the processor for detecting movement of the object to which the housing of the intelligent device is attached; and
a display means coupled to the processor;
wherein the processor is responsive to the sensor detecting movement of the object to reconfigure from a first low-power state to a second working state for a pre-determined period of time, such that during the pre-determined period of time the processor retrieves data and displays said data on the display means and wherein the processor reverts to the first low-power state when the pre-determined period of time has expired.

The length of the pre-determined period of time within which the device is in the second working state may be between 5 seconds and 20 seconds, more preferably between 5 seconds and 15 seconds, and still more preferably between 10 seconds and 15 seconds.

The length of the pre-determined period of time within which the device is in the second working state may be user adjustable.

The user may adjust the period of time that the device remains in the second working state by interacting with mechanical buttons on the device's housing or via the display means. Optionally, the user may adjust the period of time that the device remains in the second working state via a message received from a remote server using a low power radio network.

The movement sensor may be an accelerometer.

The processor may be responsive to the sensor detecting movement of the object to remotely retrieve data and display said data on the display means.

The intelligent device may comprise a wireless communications module coupled to the processor. The wireless communications module may comprise a radio and an antenna wherein said data is received over a radio frequency network. The radio frequency network may utilise a communication protocol selected from one of Zigbee, WIFI, IEEE 802.15.4, 6LowPAN, Proprietary, and z-wave protocols.

The intelligent device may comprise a power supply to charge each components of the intelligent device. In one example the power supply may comprise a battery such as a rechargeable battery, in another example the power supply may comprise a super capacitor.

The processor may be configured with processor-executable instructions such that on receipt of a reconfigure signal from the movement sensor, the processor is reconfigured from the first low-power state to the second working state and back to the first low-power state after a predetermined period of time has passed.

The processor may be configured with processor-executable instructions to retrieve and display said data on the display means. The processor-executable instructions may perform operations comprising:
establishing a communication link via the wireless communications module with a remote server;
requesting data from the remote server;
receiving the data from the server via the wireless communications module; and
displaying the data on the display of the intelligent device.

The data may be dynamic data. In one embodiment the requested data may be updated data or refreshed data.

The intelligent device may comprise a memory. The memory may be in the form of non volatile memory.

The display means may be a touch screen, a liquid crystal display (LCD), a back-lit LCD, a plurality of LED number segments, or any combination of these or any other known display means.

The display means may provide information to the user in the form of alpha-numeric lines, graphs, computer-generated graphics, videos or any combination thereof.

The memory may store screen layout configurations for providing a screen display on the display means.

The processor may further be configured with processor-executable instructions to retrieve data periodically and irrespective of whether a signal from the movement sensor has been detected. Such data may be substantially static and may be retrieved and stored to memory. Static data in this context refers to data which is not subject to rapid fluctuations such as a persons consumption of energy. An example of static data in the context of this application is price data from the supplier of the energy. The processor may be further operable to perform calculations on the static data to produce one or more results and to display said result(s) on the display means when the processor receives a signal from the sensor detecting movement of the object to which the housing of the intelligent device is attached.

The housing of the intelligent device may have a USB port to enable the device to be plugged into a remote computer. In this way, the user of the device is able to view for instance, a detailed consumption history.

### BRIEF DESCRIPTION OF THE DRAWINGS

Embodiments are described in further detail below, by way of example and with reference to the accompanying drawings, in which:

FIG. 1 is a perspective view of an intelligent device according to some embodiments;

FIG. 2 is schematic diagram of the circuitry of the intelligent device shown in FIG. 1A;

FIG. 3A is first screen layout of a display of the intelligent device shown in FIG. 1A;

FIG. 3B is a second screen layout of a display of the intelligent device shown in FIG. 1A;

FIG. 3C is a third screen layout of a display of the intelligent device shown in FIG. 1A; and

FIG. 3D is a fourth screen layout of a display of the intelligent device shown in FIG. 1A.

### DETAILED DESCRIPTION

As used herein, “intelligent device” refers to any type of device, equipment, instrument, or machine that has its own computing capability.

Embodiments of the intelligent device described herein refer to being configurable in a low power state or an ultra low power state. A low or ultra low power state may refer to any state in which the intelligent device consumes significantly less power as compared to the working state. For instance a low power state may comprise a state wherein instructions are not being executed by the processor, or a low power state may comprise a state wherein the intelligent device is in hibernation, i.e. the device appears to be turned off to a user.

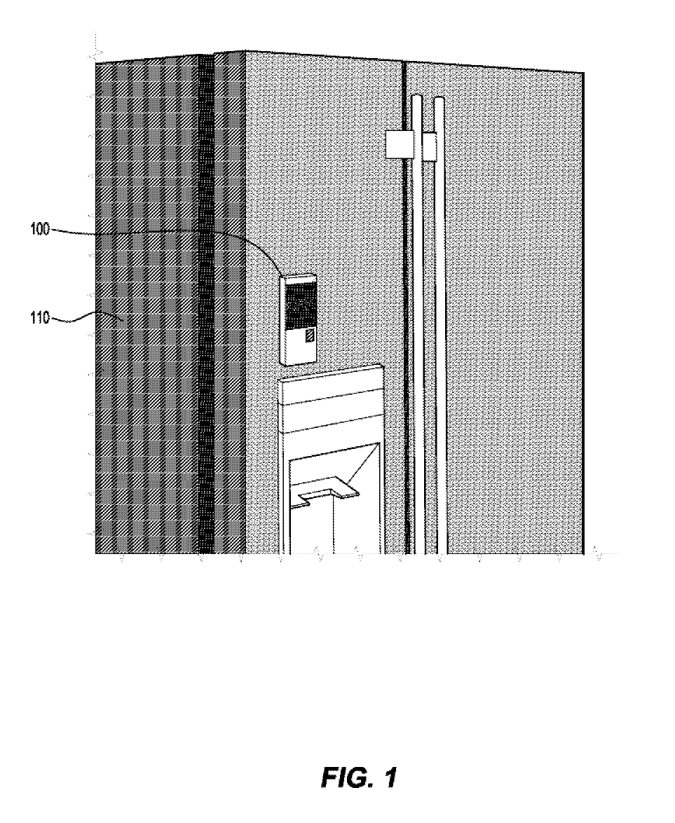

FIG. 1 illustrates one embodiment of an intelligent device 100 in accordance with the invention. The intelligent device 100 is removeably attached to a door of a refrigerator 110 by way of a magnet (not shown).

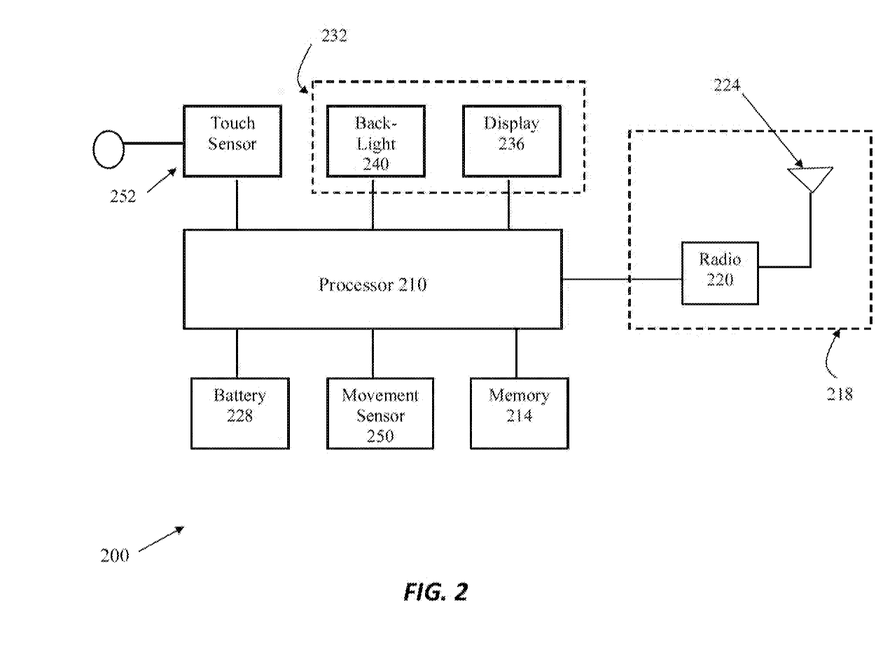

FIG. 2 schematically illustrates circuitry 200 within the intelligent device 100, which enables the intelligent device 100 to operate. Central to the circuitry is a processor 210, or microcontroller such as the ARM Cortex M3 or MSP430 coupled to a memory 214 in the form of flash memory. Flash memory is a non-volatile memory device that retains its data after the power is removed, and can be used to store data. Flash memory 214 enables the device 100 to remember its data whilst it is powered off. When the intelligent device is reconfigured to a second working state, or “woken up”, data is retrieved and stored to the flash memory 210. This process conserves significant energy by allowing the intelligent device 100 to turn itself off when not in use.

Further coupled to the processor 210 is a wireless communications module 218. The wireless communications module includes a radio which in this embodiment is a Zigbee radio 220 and an antenna 224. Zigbee and Wifi radios utilise low-power wireless communications protocol.

A movement sensor is provided in the form of a digital MEMS 3-axis accelerometer 250. The accelerometer 250 has an interrupt-output pin which is interfaced with an I/O pin of the processor 210. When the accelerometer detects motion the interrupt pin is asserted which wakes up the processor 210. The wakeup interrupt is based on “OR” logic, whereby at least one of the acceleration data points on X, Y or Z axis is beyond the preset threshold.

The processor 210 on receiving the wakeup interrupt reconfigures from a first low-power state into a second working state. The processor 210 is in effect “woken up” and switches on peripheral devices such as the back light 240 to the display 236. The processor 210 is configured with processor-executable instructions such that on receipt of the wakeup interrupt signal the processor (1) establishes a communication link via the wireless communications module 218 with a remote server; (2) requests updated data from the remote server, (3) receives the updated data from the server via the wireless communications module 218; and (4) displays the data on a display of the intelligent device. Updated data is temporarily stored to non volatile memory 214. The processor 210 is programmed such that the data is displayed only for as long as the pre-determined period of time, which in this example is 10 seconds. At the end of the pre-determined period of time the configuration of the processor reverts from the second working state to the first low-power state.

Further coupled to the processor 210 is a user interface 232 for interacting with a user and for communicating information to the user. The user interface 232 includes a display 236 in the form of a liquid crystal display (LCD), and a back light in the form of light emitting diodes (LEDs) 240. The LEDs 240 can emit light of different wavelengths to indicate different status conditions. Such LEDs may be configured to flash or emit continuous light in response to commands from the processor 210.

The memory 214 stores screen layout configurations for providing a variety of screen displays on the user interface.

The processor 210 is further configured with processor-executable instructions to retrieve data periodically and irrespective of whether a signal from the movement sensor has been received. An example of such data is new price data obtainable from the remote server. The processor 210 is further configured with computer executable instructions to periodically “wake up” and perform calculations on data stored to memory, for instance, to perform historical averages.

It should be appreciated that the invention is not limited to the type of data that can be transmitted. Moreover data may be transmitted in many different ways. Whilst data is transmitted to the intelligent device on-demand, substantially in real-time, data may be stored for a period of time before being displayed. Still further, blocks of data may be periodically transmitted. Data can also be deleted when a data record exceeds a predetermined storage time, and/or the oldest data record is deleted first after a predetermined storage size limit has been reached.

Further coupled to the processor 210 is a power supply 222 in the form of a Lithium polymer (LiPO) battery 222. LiPO batteries are rechargeable and have a high energy storage to weight ratio. The power supply 222 may also include circuitry battery (not shown) for monitoring the charge of the battery. Power supply circuitries which can perform such a function are well-known in the electronic device arts. Because the intelligent device 100 is configurable in either a first low-power state or a second working state, and only enters the second working state in response to a predetermined event and only for a predetermined time, the LiPO battery is able to last for several months between charges.

The touch sensor 252 responds to a user's touch on the display to for instance, change the screen display or provide further information related to the data displayed on the screen.

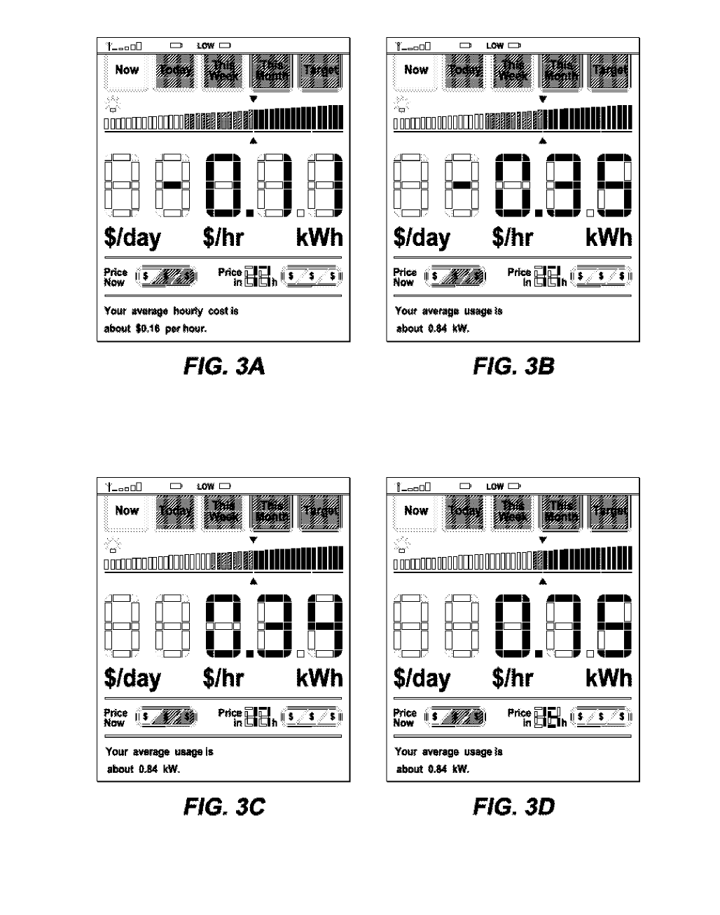

FIGS. 3A to 3D show a series of images of the display of the intelligent device of an in-home display, where each image is taken at a different time in the day. The screen display in these examples informs the user of the user's consumption of energy in the home. All the screens show the current usage “now”. Whilst the screen configuration of FIG. 3A indicates the cost that user is incurring per hour, FIGS. 3B to 3D show the average useage in kW. The screen display is configured such that a user can switch from a “now” setting to a “today”, “this week”, “this month” and “target” setting.

As will be evident from reading the foregoing, intelligent devices configured in accordance with the invention use significantly less power than known ambient devices displaying data. Such ambient devices continuously display data to a user. Indeed one of the most significant contributors to a short battery life is the continual illumination of a device's display screen. The battery life of an ambient device may be further diminished when the device's processor is employed in processor intensive activities.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. For instance, the user interface 232 may include an audible output device (not shown), for example a speaker which is coupled to the processor 210 via a digital-to-analog converter (not shown) for converting digital audio files stored in memory 214 to analog signals playable by the speaker. The audible output device may simply provide audible instructions to a user when an event is detected or may provided an audio equivalent of the data to assist visually impaired users.

Whilst the accelerometer above has been described as a 3-axis accelerometer whereby movement is essentially sensed along a single axis, the movement sensor may be a 1-dimensional accelerometer. In this example, when the fridge door to which the intelligent device is mounted is closed, the axis is substantially perpendicular to the device's front-to-rear longitudinal axis. The accelerometer is directional and can sense acceleration having a component in either direction along the axis. The accelerometer is relatively insensitive to accelerations in a direction perpendicular to the axis. Acceleration measured along axis in a first direction is defined to be in a negative direction. Similarly, acceleration measured in a second direction is defined to be acceleration in a positive direction. Therefore, opening the fridge door results in a positive acceleration signal. The accelerometer is then programmed on detection of a positive acceleration signal to (1) check that the positive acceleration signal is beyond a pre-determined level and on determining that the positive acceleration signal is beyond the pre-determined level to (2) send a reconfigure signal to the processor. The processor on receiving the reconfigure signal from the accelerometer is operable to reconfigure from a first low-power state into a second working state and the processor is in effect “woken up”.

Still further, the intelligent device may provide a user with an option to adjust manual brightness, for instance a soft control on the display of the intelligent device may enable the user to flip between two or more levels of brightness. In addition, or optionally, the intelligent device may incorporate an ambient light sensor. The processor may be configured with processor-executable instructions to respond and adjust the level of the display brightness as a result of any light the ambient light sensor detects.

1. An intelligent device for the display of data in a power constrained environment, the intelligent device comprising:
a housing;
an attachment means to attach the housing of the intelligent device to an object;
a processor housed within the housing;
a movement sensor coupled to the processor for detecting movement of the object to which the housing of the intelligent device is attached; and
a display means coupled to the processor;
wherein the processor is responsive to the sensor detecting movement of the object to reconfigure from a first low-power state to a second working state for a pre-determined period of time, such that during the pre-determined period of time the processor retrieves data and displays said data on the display means and wherein the processor reverts to the first low-power state when the pre-determined period of time has expired.

2. The intelligent device according to claim 1, wherein the length of the pre-determined period of time within which the device is in the second working state is between 10 seconds and 15 seconds.

3. The intelligent device according to claim 1, wherein the length of the pre-determined period of time within which the device is in the second working state is user adjustable.

4. The intelligent device according to claim 1, wherein the movement sensor is an accelerometer.

5. The intelligent device according to claim 1, wherein the intelligent device further comprises a wireless communications module coupled to the processor, the wireless communications module including a radio and an antenna and wherein said data is received over a radio frequency network.

6. The intelligent device according to claim 5, wherein the radio frequency network utilises a communication protocol selected from one of Zigbee, WIFI, IEEE 802.15.4, 6LowPAN, Proprietary, and z-wave protocols.

7. The intelligent device according to claim 1, further comprising a power supply to charge each component of the intelligent device.

8. The intelligent device according to claim 1, wherein the processor is configured with processor-executable instructions such that on receipt of an interrupt signal from the movement sensor, the processor is reconfigured from the first low-power state to the second working state and back to the first low-power state after a predetermined period of time has passed.

9. The intelligent device according to claim 8, wherein when the processor is configured in the second working state, the processor-executable instructions perform operations comprising:
establishing a communication link via the wireless communications module with a remote server;
requesting data from the remote server;
receiving the data from the server via the wireless communications module; and
displaying the data on the display of the intelligent device.

10. The intelligent device according to claim 9, wherein the received data is dynamic data, said data comprising updated data or refreshed data.

11. The intelligent device according to claim 9, wherein the processor is configured with processor-executable instructions to retrieve additional data periodically and irrespective of whether a signal from the movement sensor has been detected.

12. The intelligent device according to claim 11, wherein the processor is operable to perform calculations on the retrieved additional data to produce one or more results and to display said result(s) on the display means when the processor receives an interrupt signal from the movement sensor.

13. The intelligent device according to claim 1, wherein the display means is a touch screen, a liquid crystal display (LCD), a back-lit LCD, a plurality of LED number segments, or any combination of these or any other known display means.

14. The intelligent device according to claim 1, wherein the intelligent device further comprises a memory.
